(19) United States
(12) Patent Application Publication
(10) Pub. No.: US 2012/0008077 A1
(43) Pub. Date: Jan. 12, 2012

(54) ALIGNMENT LAYER MATERIAL, MANUFACTURING PROCESS, AND DISPLAY PANEL

(76) Inventors: Zhaoyu CHEN, Shenzhen (CN); Yang YANG, Shenzhen (CN)

(21) Appl. No.: 12/891,807

(22) Filed: Sep. 28, 2010

(30) Foreign Application Priority Data
Jul. 7, 2010 (CN) 201010230485.5

(51) Int. Cl. G02F 1/1337; C08J 3/28; B05D 3/06; C08K 5/101

(52) U.S. Cl. 349/123; 524/315; 522/162; 427/520

(57) ABSTRACT

An alignment layer material is provided. The alignment material includes approximately 3%-50% weight percentage of Methyl acrylate, approximately 15%-50% weight percentage of Acrylate Monomer, and approximately 10%-50% weight percentage of Polyurethane modified Acrylic Resin.

### CROSS-REFERENCES TO RELATED APPLICATIONS

This application claims the priority of Chinese patent application number 201010230485.5, filed on Jul. 7, 2010, the entire contents of which are incorporated herein by reference.

### FIELD OF THE INVENTION

The present invention generally relates to liquid crystal display (LCD) technologies and, more particularly, to materials, processes, and display modules involving LCD alignment layers.

### BACKGROUND

With the rapid growth of information technology, liquid crystal display (LCD) panels have been used in our everyday life. The LCD panel industry has expanded from the notebook/laptop centered applications to other market applications, such as liquid crystal screens, portable consumer audio/video products, mobile phones, and LCD TV, etc.

Different market applications require continuous improvements on LCD's view angle, contrast, and display uniformity, etc. New materials and new manufacturing processes have been proposed and invented to meet these challenges. Among them, technologies and improvements on the alignment layer are important to the performance of LCD panels.

In general, there are three types of liquid crystal molecule arrangements with respect to the alignment layer: a homogeneous alignment, in which the long axis of liquid crystal molecules are parallel to the alignment layer; a heterogeneous or vertical alignment, in which the long axis of liquid crystal molecules are perpendicular to the alignment layer; and a pretilt alignment, in which the liquid crystal molecules are tilted to a particular angle against the alignment layer to reach the desired alignment uniformity. The pretilt angle is decided by the physicochemical properties of the alignment layer, which include the hydrogen bond, the Vander Waals forces, the dipole-dipole forces, and mechanical properties, e.g., the groove or the surface condition of the alignment layer.

In a liquid crystal display panel, a liquid crystal layer comprises many liquid crystal molecules. Because the liquid crystal molecules have different dielectric anisotropy in the direction parallel to the molecular axis from the direction perpendicular to the molecule axis, an electric field can be applied to control the alignment direction of the liquid crystal molecules. On the other hand, because liquid crystal also has the characteristics of double refraction and can change the polarization direction of passing polarized lights, the alignment direction change of the liquid crystal molecules caused by the electric field can further result in optical changes of the passing lights.

Thus, in a liquid crystal display panel, liquid crystal molecules need to be aligned in a certain direction in order to achieve a desired display effect. However, keeping a stable and even alignment of the liquid crystal molecules requires alignment technologies. Because of the high anchoring strength between an alignment layer and the liquid crystal layer, liquid crystal molecules can restore their original alignment based on the strong anchoring even after the electric field is removed.

Major alignment layer manufacturing technologies include five types of processes, ion and plasma beam alignment, impregnated surfactant alignment, vapor deposition of silicon oxide alignment, photo alignment, and rubbing alignment.

For the vapor deposition of silicon oxide alignment, under a high-degree vacuum condition, silicon oxide is evaporated into gas and deposited onto the Indium Tin Oxide (ITO) coated substrate surface to grow long cylindrical silicon oxide. The liquid crystal alignment can be achieved by controlling the tilt angle of the long cylindrical silicon oxide and the deposition density of the silicon oxide. Even though this process can reliably create an accurate alignment angle for the liquid crystal molecules, the high vacuum and high temperature fabrication process makes it difficult for large scale production, and is only available for low volume, high end liquid crystal display (LCD) panels.

For the ion and plasma beam alignment, DLC (Diamond Like Carbon) is evaporated and deposited onto the Indium Tin Oxide (ITO) surface. Further, filtered linear ion or plasma beam is used to bombard the deposited DLC to destroy the surface structure of the DLC, thus a long cylindrical structure similar to above silicon oxide can also be created to align liquid crystal molecules. This approach can also provide high quality alignment uniformity. However, this fabrication process is still not suitable for large scale production and also associated with high cost.

The disclosed methods and systems are directed to solve one or more problems set forth above and other problems.

### BRIEF SUMMARY OF THE DISCLOSURE

One aspect of the present disclosure includes an alignment layer material. The alignment material includes approximately 3%-30% weight percentage of methyl acrylate, approximately 15%-50% weight percentage of acrylate monomer, and approximately 10%-50% weight percentage of polyurethane modified acrylic resin.

Another aspect of the present disclosure includes a manufacturing process of an alignment layer. The process includes providing a transparent substrate and an alignment layer material, and coating the alignment layer material on one side of the transparent substrate. The process also includes curing the coated alignment layer material by UV irradiation, and forming alignment on a surface of the alignment layer material to create the alignment layer. The alignment layer material includes approximately 3%-30% weight percentage of methyl acrylate, approximately 15%-50% weight percentage of acrylate monomer, and approximately 10%-50% weight percentage of polyurethane modified acrylic resin.

Another aspect of the present disclosure includes a liquid crystal display (LCD) panel. The LCD panel includes a first transparent substrate, and a second transparent substrate arranged in parallel to the first transparent substrate with distance. The LCD panel also includes a common electrode coupled to the first transparent substrate, a pixel electrode layer coupled to the second transparent substrate, and a liquid crystal layer placed between the first substrate and the second substrate and controlled by an electric field formed by the common electrode and the pixel electrode layer. Further, the LCD panel includes a first alignment layer formed on a surface of the first transparent substrate and covering the common electrode, and a second alignment layer formed on a surface of the second transparent substrate and covering the pixel electrode layer. The first alignment and the second alignment are made of an alignment layer material including approximately 3%-30% weight percentage of methyl acrylate, approximately 15%-50% weight percentage of acrylate monomer, and approximately 10%-50% weight percentage of polyurethane modified acrylic resin.

Other aspects of the present disclosure can be understood by those skilled in the art in light of the description, the claims, and the drawings of the present disclosure.

### BRIEF DESCRIPTION OF THE DRAWINGS

FIG. 1 illustrates a structural diagram of an exemplary liquid crystal display panel consistent with the disclosed embodiments;

FIG. 2 illustrates an exemplary manufacturing process consistent with the disclosed embodiments;

FIG. 3 illustrates an exemplary alignment layer manufacturing process consistent with the disclosed embodiments;

FIG. 4 illustrates an exemplary liquid crystal panel during alignment layer manufacturing process consistent with the disclosed embodiments;

FIG. 5 illustrates an exemplary rubbing process consistent with the disclosed embodiments;

FIG. 6 illustrates another exemplary liquid crystal panel consistent with the disclosed embodiments;

FIG. 7 illustrates an exemplary alignment manufacturing process consistent with the disclosed embodiments;

FIG. 8 illustrates a block diagram of photo alignment consistent with the disclosed embodiments; and

FIG. 9 illustrates an exemplary alignment layer structure consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the draws to refer to the same or like parts.

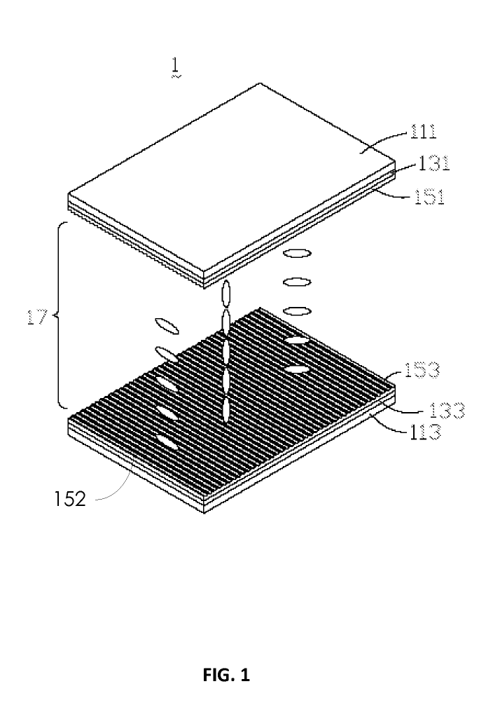

FIG. 1 shows a structural diagram of an exemplary liquid crystal display (LCD) panel 1 consistent with the disclosed embodiments. As shown in FIG. 1, LCD panel 1 includes a first substrate 111, a second substrate 113, a common electrode 131, a pixel electrode layer 133, a first alignment layer 151, a second alignment layer 153, and a liquid crystal layer 17. First substrate 111 and second substrate 113 may be arranged correspondingly and may be made of transparent materials.

First substrate 111 and second substrate 113 may be placed in parallel with a certain distance and liquid crystal layer 17 is sandwiched between first substrate 111 and second substrate 113. Between first substrate 111 and liquid crystal layer 17, from top down (in the direction from first substrate 111 to liquid crystal layer 17), common electrode 131 and first alignment layer 151 may be arranged in sequence. Further, between liquid crystal layer 17 and second substrate 113, in the same direction, pixel electrode layer 133 and second alignment layer 153 may be arranged in sequence.

First substrate 111 and second substrate 113 may be made by any appropriate material and in any appropriate shape. For example, first substrate 111 and second substrate 113 may be transparent substrates with a high light transmittance and in a shape of rectangle, such as sodium glass plates or polyethylene terephthalate (PET) plates.

Common electrode 131 may include any appropriate type of transparent electrode. For example, common electrode 131 may be a conductive film of Indium Tin Oxide (ITO), and may be formed on a surface of first substrate 111 through etching techniques. Pixel electrode layer 133 may also include any appropriate type of transparent electrode, such as a conductive film of ITO on the surface of substrate 113. Common electrode 131 and pixel electrode layer 133 may be arranged correspondingly to generate a controllable electric field, under which liquid crystal molecules of liquid crystal layer 17 can be rotated or tilted along a pre-arranged angle. That is, the long axis of the liquid crystal molecules may be controlled to rotate under the electric field.

First alignment layer 151 and second alignment layer 153 may be arranged by coating the surfaces of substrate 111 and substrate 113, respectively. First alignment layer 151 and second alignment layer 153 also cover common electrode 131 and pixel electrode layer 133, respectively. Further, first alignment layer 151 and second alignment layer 153 may both have a plurality of micro-structures on their surfaces. In certain embodiments, first alignment layer 151 and second alignment layer 153 both have a plurality of micro grooves 152. That is, the micro-structures of first alignment layer 151 and second alignment layer 153 may be micro-grooves 152.

Further, micro-grooves 152 may include a plurality of v-shaped grooves arranged in parallel, and the stretch direction of v-shaped grooves 152 of first alignment layer 151 may be perpendicular to the stretch direction of v-shaped grooves 152 of second alignment layer 153. Further, first alignment layer 151 and second alignment layer 153 may be made of ultra-violet (UV) curing adhesive, which is a polymer formed with a mix under certain UV light irradiation, and the mix includes Polyurethane modified Acrylic Resin, Methyl acrylate, and Acrylate Monomer according to a certain ratio.

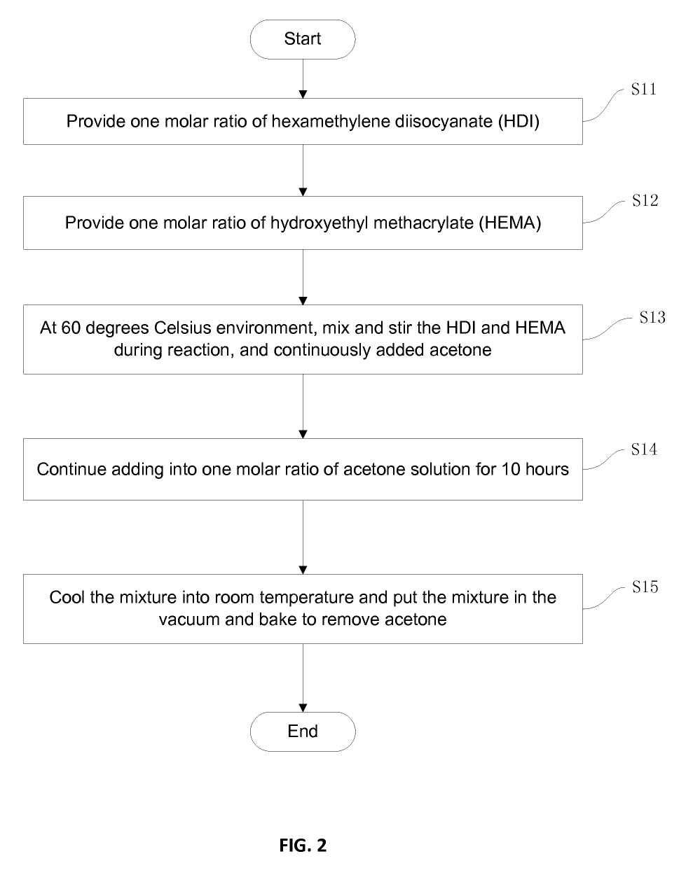

In certain embodiments, the Polyurethane modified Acrylic resin in the mix is made in dark-room environment using certain processes. FIG. 2 shows an exemplary process of making the polyurethane modified acrylic resin.

As shown in FIG. 2, at the beginning, one molar ratio of hexamethylene diisocyanate (HDI) is provided (S11) and one molar ratio of hydroxyethyl methacrylate (HEMA) is also provided (S12). At 60 degrees Celsius environment, the HDI and HEMA are mixed together and stirred during reaction, and acetone is continuously added to maintain about 50% solid content, with a reaction time of 6 hours (S13). One molar ratio of acetone solution (about 50 wt %) is added in continuously for 10 hours (S14), and then the mixture is cooled into room temperature and baked in the vacuum to remove acetone and then to obtain the final solid polyurethane modified acrylic resin (S15).

As disclosed, confirmed by experiments, the alignment layer material can be made by the following two examples. In one example, first mixing Polyurethane modified Acrylic Resin, Methyl acrylate, Acrylate Monomer and 2-Hydroxy-2-methylpropiophenone in weight percentage listed in Table 1.

TABLE 1

| Ingredients | Percentage (weight: 100 g) |
|---|---|
| Polyurethane modified Acrylic Resin | 38% (38 g) |
| Methyl acrylate | 20% (20 g) |
| Acrylate Monomer | 40% (40 g) |
| 2-Hydroxy-2-methylpropiophenone | 2% (2 g) |

Then stirring the mixture by a magnetic agitator in a dark-room environment for 90 minutes, and the final product is the alignment layer material.

In another example, first mixing Methyl acrylate, Acrylate Monomer, Polyurethane modified Acrylic Resin and 1-Hydroxycyclohexyl Phenyl Ketone in weight percentage listed in Table 2.

TABLE 2

| Ingredients | Percentage (weight: 1000 g) |
|---|---|
| Polyurethane modified Acrylic Resin | 40% (400 g) |
| Methyl acrylate | 8% (80 g) |
| Acrylate Monomer | 50% (500 g) |
| 1-Hydroxycyclohexyl Phenyl Ketone | 2% (20 g) |

Then stirring the mixture by a magnetic agitator in dark for 60 minutes, the final product is the alignment layer material.

Therefore, as confirmed by multiple tests, the alignment layer material can be formed when the weight percentage of each component falls in the listed range: Polyurethane modified Acrylic Resin approximately 10%-50%, preferred approximately 35%-50%; Methyl acrylate approximately 3%-30%, preferred approximately 8%-28%; Acrylate Monomer approximately 15%-50%, preferred approximately 40%-50%.

In the above processes, 2-Hydroxy-2-methylpropiophenone or 1-Hydroxycyclohexyl Phenyl Ketone may be provided as photon initiating agent to induce chemical reactions among Polyurethane modified Acrylic Resin, Methyl acrylate, and Acrylate Monomer to form the polymer surface. Further, the alignment layer material can also be doped with a certain proportion of 2-methyl-2-(4-morpholinyl)-[4-(methylthio)phenyl]-1-acetone and other cleavage type of initiator to induce reactions.

Other additive agents, including dye, leveling agent, plasticiser, photosensitizer and defoamer, may also be added to the alignment layer material. Generally the percentage of the additive agents in the alignment layer material is within 0.1%-10%.

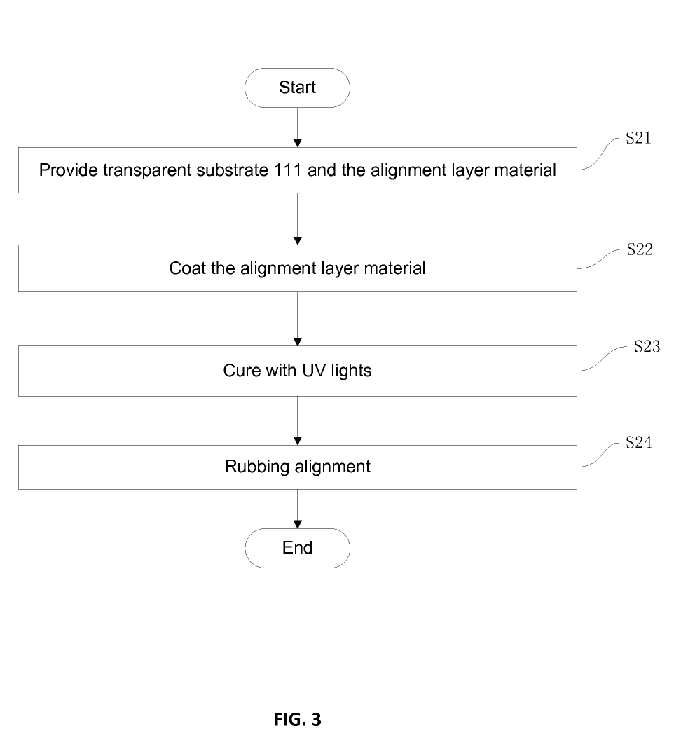

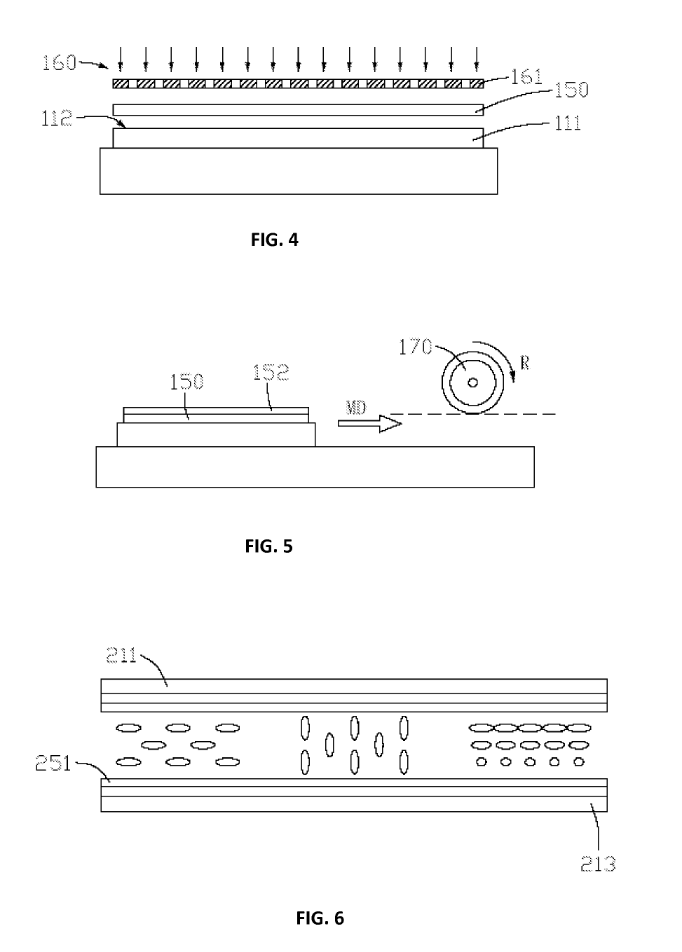

FIG. 3 shows an exemplary alignment layer manufacturing process consistent with the disclosed embodiments. It is understood that the above disclosed alignment materials may be used in the manufacturing process for making alignment layer 151 and alignment layer 153. FIG. 4 shows a corresponding liquid crystal panel during alignment layer manufacturing process.

As shown in FIG. 3, at the beginning, transparent substrate 111 and the alignment layer material are provided (S21). In particular, as shown in FIG. 4, transparent substrate 111 may a rectangle glass substrate with a coating surface 112. The alignment material 150 is a type of above-described alignment material (e.g., FIG. 2).

The alignment material 150 may then be coated on substrate 111 (S22). For example, a layer of the alignment material 150 is evenly coated on the coating surface 112 of substrate 111 using a roller printing process. The coating can also be done by using spin coating, roller coating, dip coating, spray coating or gravure coating, etc. Any appropriate coating process may be used.

Further, the alignment layer material coated on substrate 111 may be cured by UV irradiation (S23). As shown in FIG. 4, a UV light source 160 and an optical collimating module 161 are used. UV light source 160 may be a high pressure mercury lamp to provide UV lights. Optical collimating module 161 collimates the UV lights from UV light source 160 and creates an evenly illumination on coating surface 112 with alignment layer material 150. The wavelength of the UV light source 160 is set to approximately 365 nm to cure the alignment layer material 150.

During UV light irradiation, the photon initiating agent in the alignment layer material 150 absorbs UV lights and generates living radicals, which induces the polymerizing & cross-linking of the monomers, and direct chemical reactions, and thus change the alignment layer material 150 from a liquid state to a solid state in about several seconds.

After the alignment material 150 is cured, the alignment material 150 is rubbed to form alignment layer 151 (S24). This may be called a rubbing alignment. FIG. 5 shows an exemplary rubbing process. As shown in FIG. 5, a rubbing roller 170, such as a cloth roller, is provided to strike the coating surface of the alignment layer material 150 in one direction. The mechanical rubbing on the coating of the alignment layer material 150 stretches the polymer main chain in one direction and creates a plurality of micro-structures to align liquid crystal molecules.

The micro-structure alignment mechanism may include a groove alignment mechanism and a polymer chain alignment mechanism. In the groove alignment, when the long axis direction of the liquid crystal molecules is parallel to the direction of the groove, the liquid crystal molecules have the least distortion and the lowest surface energy, thus it makes the liquid crystal molecules to align along the direction of the groove. In polymer chain alignment, when the polymer is rubbed unidirectionally, it will result in an ordered surface. And the lowest interaction energy will be achieved when the liquid crystal molecules align along the polymer chain stacks.

Further, similar to above alignment layer on first substrate 111, the second alignment layer 153 can also be formed on the surface of substrate 113. However, the alignment direction of second alignment layer 153 is perpendicular to the alignment direction of the first alignment layer 151.

Therefore, two alignment layers 151 and 153 can be formed separately on the opposing surface of substrates 111 and 113, respectively. Because of the alignment effect of the alignment layers 151 and 153, the liquid crystal molecules in liquid crystal layer 17 arrange themselves in a helical structure, so the incident light can pass through. And by controlling the alignment direction of the liquid crystal molecules, the passing light will be changed to reach a desired display. Further, the above process for making alignment layers may also add steps making common electrode 131 and pixel electrode layer 133 on substrates 111 and 113, respectively.

The alignment layer material in the liquid crystal display panel 1 may contain Polyurethane modified Acrylic Resin, Methyl acrylate and Acrylate Monomer with their weight percentage as: Polyurethane modified Acrylic Resin approximately 10%-50%, Methyl acrylate approximately 3%-30% and Acrylate Monomer approximately 15%-50%. The alignment layer material made by this formula exhibits substantial adhesive strength, high level light transmittance and more suitable for rubbing alignment.

FIG. 6 illustrates another exemplary liquid crystal panel consistent with the disclosed embodiments. As shown in FIG. 6, liquid crystal display panel 2 may include substrates 211 and 213, a liquid crystal layer (not shown), and an alignment layer 251 (other components may be similar to FIG. 1 and thus omitted). However, liquid crystal display panel 2 may be a flexible panel. Substrates 211 and 213 may be flexible substrates, such as those made of polymers like PET (Polyethylene Terephthalate), PP (Polypropylene), PC (Polycarbonate), etc.

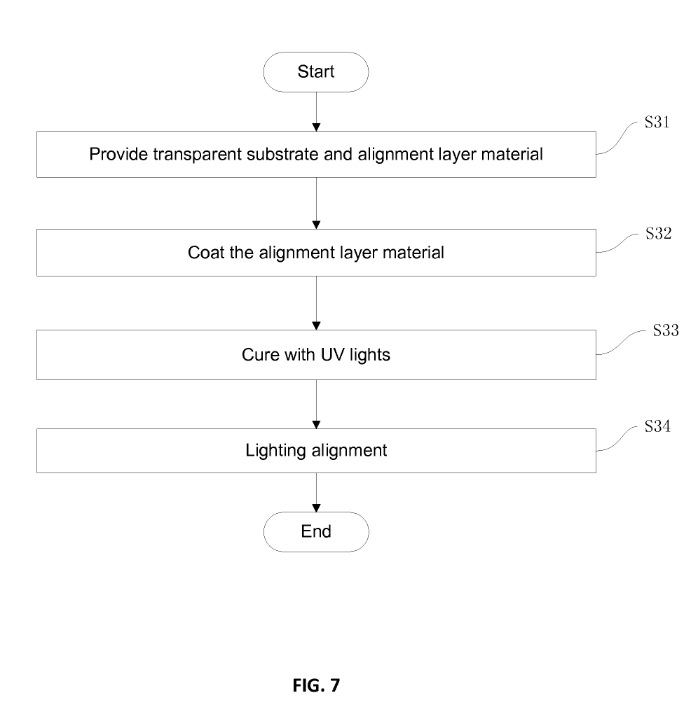

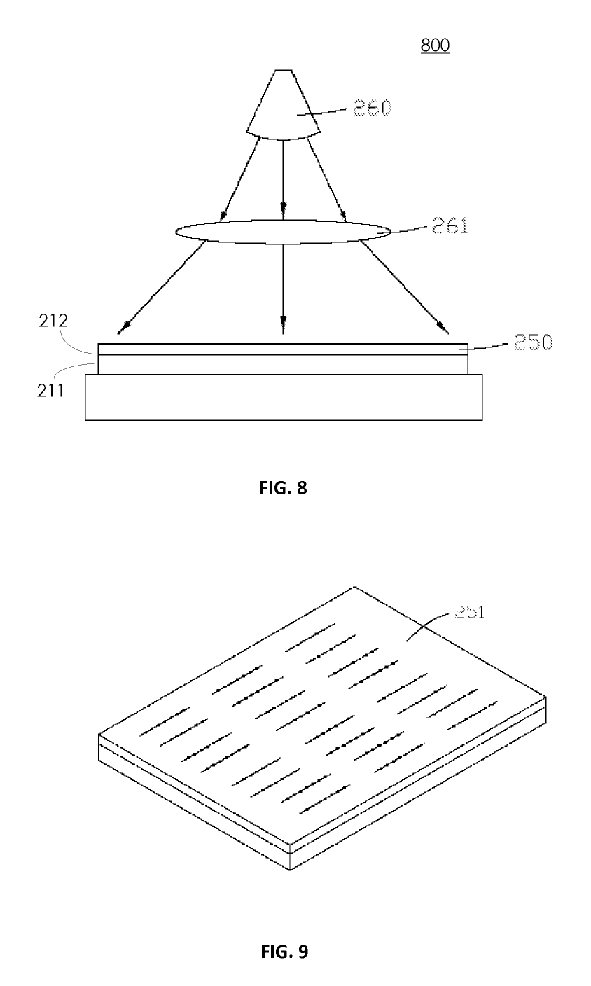

FIG. 7 shows an exemplary alignment manufacturing process of liquid crystal panel 2. As shown in FIG. 7, at the beginning, transparent substrate 211 and the alignment layer material 250 are provided (S31). In particular, as shown in FIG. 8, transparent substrate 211 may be a polymer substrate with a coating surface 212. The alignment material 250 is a type of above-described alignment material (e.g., FIG. 2).

Similar to the alignment material 150 with respect to substrate 111, the alignment layer material 250 may then be coated on substrate 211 (S32), and the alignment layer material coated on substrate 211 may be cured by UV irradiation (S33). Further, the alignment material 250 is irradiated by UV lights to form alignment layer 251 (S34). This may be called a photo alignment.

As shown in FIG. 8, a UV light photo alignment system includes a UV light source 260, a photo mask 261, and alignment layer material 250 as coated on surface 212 of substrate 211. UV light source 260 coupled with photo mask 261 provides linearly polarized UV lights to irradiate alignment layer material 250 and the wavelength of the UV light may be set to be approximately 100-250 nm. The energy density of the UV irradiation may be in a range of approximately 100-1000 mj/cm². The UV irradiation induces the bond-making or bond-breaking of the polymers on the surface of the alignment layer material 250, which creates an aligned orientation of the polymer chain. And it results in the alignment of the polymer material along the polarization direction, which forms the alignment layer 251, as shown in FIG. 9. The reaction mechanism includes photoisomerization, photodecomposition and photopolymerization, etc.

Therefore, alignment layer 251 is aligned through UV light exposure after the alignment layer material 250 is cured. Because of the thermal stability and alignment stability of the alignment layer formed by the above photo alignment, and no need of the vacuum condition, the disclosed methods may be practical in large scale manufacturing. Further, because the disclosed alignment layer material can be processed in low temperature, it can be applied on polymer substrates to produce flexible LCD panels.

What is claimed is:

1. An alignment layer, comprising:
approximately 3%-30% weight percentage of Methyl acrylate;
approximately 15%-50% weight percentage of Acrylate Monomer; and
approximately 10%-50% weight percentage of Polyurethane modified Acrylic Resin.

2. The alignment layer according to claim 1, wherein:
the Polyurethane modified Acrylic Resin is created by a chemical reaction of hexamethylene diisocyanate and 2-Hydroxyethyl Methyl acrylate in an acetone solution.

3. The alignment layer according to claim 2, further comprising:
one of a group consisting of dye, leveling agent, plasticiser, photosensitizer and defoamer, and combination thereof.

4. The alignment layer according to claim 2, wherein:
a total weight percentage of dye, leveling agent, plasticiser, photosensitizer and defoamer is approximately 0.1%-10%.

5. The alignment layer according to claim 1, further comprising:
an initiating agent.

6. The alignment layer according to claim 5, wherein:
the initiating agent is one of 2-Hydroxy-2-methylpropiophenone, 1-Hydroxycyclohexyl phenyl ketone, and 2-methyl-2-(4-morpholinyl)-1-[4-(methylthio)phenyl]-1-acetone.

7. The alignment layer according to claim 1, wherein:
a weight percentage of Methyl acrylate, Acrylate Monomer, and Polyurethane modified Acrylic Resin is approximately 8%-28%, 40%-50%, and 35%-50%, respectively.

8. The alignment layer according to claim 7, wherein:
a weight percentage of Methyl acrylate, Acrylate Monomer, and Polyurethane modified Acrylic Resin is approximately 20%, 40%, and 38%, respectively.

9. A manufacturing process of an alignment layer, the process comprising:
providing a transparent substrate and an alignment layer material;
coating the alignment layer material on one surface of the transparent substrate;
curing the coated alignment layer material by UV irradiation;
forming alignment on a surface of the alignment layer material to obtain the alignment layer,
wherein the alignment layer material comprises:
approximately 3%-30% weight percentage of Methyl acrylate;
approximately 15%-50% weight percentage of Acrylate Monomer; and
approximately 10%-50% weight percentage of Polyurethane modified Acrylic Resin.

10. The manufacturing process according to claim 9, wherein the energy density of the UV irradiation is in a range of 100-1000 mj/cm2.

11. The manufacturing process according to claim 9, wherein the alignment is a rubbing alignment.

12. The manufacturing process according to claim 9, wherein the alignment is a photo alignment.

13. The manufacturing process according to claim 9, wherein:
the Polyurethane modified Acrylic Resin is created by a chemical reaction of hexamethylene diisocyanate and 2-Hydroxyethyl Methyl acrylate in an acetone solution.

14. The manufacturing process according to claim 9, wherein the alignment layer material further comprises:
one of a group consisting of dye, leveling agent, plasticiser, photosensitizer and defoamer, and combination thereof.

15. The manufacturing process according to claim 14, wherein:
a total weight percentage of dye, leveling agent, plasticiser, photosensitizer and defoamer is approximately 0.1%-10%.

16. The manufacturing process according to claim 9, wherein the alignment layer material further includes:
an initiating agent being one of 2-Hydroxy-2-methylpropiophenone, 1-Hydroxycyclohexyl phenyl ketone, and 2-methyl-2-(4-morpholinyl)-1-[4-(methylthio)phenyl]-1-acetone.

17. The alignment layer according to claim 9, wherein: a weight percentage of Methyl acrylate, Acrylate Monomer, and Polyurethane modified Acrylic Resin is approximately 8%-28%, 40%-50%, and 35%-50%, respectively.

18. The alignment layer according to claim 9, wherein: a weight percentage of Methyl acrylate, Acrylate Monomer, and Polyurethane modified Acrylic Resin is approximately 20%, 40%, and 38%, respectively.

19. A liquid crystal display (LCD) panel, comprising:
a first transparent substrate;
a second transparent substrate arranged in parallel to the first transparent substrate with distance;
a common electrode coupled to the first transparent substrate;
a pixel electrode layer coupled to the second transparent substrate; and
a liquid crystal layer sandwiched between the first substrate and the second substrate and controlled by an electric field formed by the common electrode and the pixel electrode layer;
a first alignment layer formed on a surface of the first transparent substrate and covering the common electrode; and
a second alignment layer formed on a surface of the second transparent substrate and covering the pixel electrode layer,
wherein the first alignment layer and the second alignment layer are made of an alignment layer material including:
approximately 3%-30% weight percentage of Methyl acrylate;
approximately 15%-50% weight percentage of Acrylate Monomer; and
approximately 10%-50% weight percentage of Polyurethane modified Acrylic Resin.

20. The LCD panel according to claim 19, wherein:
the Polyurethane modified Acrylic Resin is created by a chemical reaction of hexamethylene diisocyanate and 2-Hydroxyethyl Methyl acrylate in an acetone solution.

21. The LCD panel according to claim 19, wherein the alignment layer material further includes:
dye, leveling agent, plasticiser, photosensitizer and defoamer.

22. The LCD panel according to claim 21, wherein:
a total weight percentage of dye, leveling agent, plasticiser, photosensitizer and defoamer is approximately 0.1%-10%.

23. The LCD panel according to claim 19, wherein the alignment layer material further includes:
an initiating agent being one of 2-Hydroxy-2-methylpropiophenone, 1-Hydroxycyclohexyl phenyl ketone, and 2-methyl-2-(4-morpholinyl)-1-[4-(methylthio)phenyl]-1-acetone.
